(19) United States
(12) Patent Application Publication
(10) Pub. No.: US 2026/0237559 A1
(43) Pub. Date: Aug. 13, 2026

(54) CAPACITOR

(71) Applicant: Panasonic Intellectual Property Management Co., Ltd., Osaka (JP)

(72) Inventors: HIROKI TAKEOKA, Nara (JP); SHIGEHIRO YOSHIUCHI, Kyoto (JP)

(21) Appl. No.: 19/460,454

(22) Filed: Jan. 27, 2026

(30) Foreign Application Priority Data
Feb. 10, 2025 (JP) 2025-020167

(51) Int. Cl. H01G 2/10

(52) U.S. Cl. CPC H01G 2/103

(57) ABSTRACT

A capacitor includes a capacitor element, a frame body surrounds the capacitor element and includes a pair of opening faces facing each other, and a first resin portion that is disposed inside the frame body and seals the capacitor element. The capacitor element is disposed between the pair of opening faces. The first resin portion is softer than the frame body.

### BACKGROUND

### Technical Field

The present disclosure relates generally to a capacitor, and more particularly to a capacitor including a capacitor element.

### Description of the Related Art

Unexamined Japanese Patent Publication No. 2013-084787 discloses a capacitor. The capacitor includes a capacitor element having an electrode on an end face, a first electrode plate having a first external connection terminal, a second electrode plate having a second external connection terminal, a case, and a resin.

Then, the first electrode plate is connected to one end face of the capacitor element, the second electrode plate is connected to the other end face, the capacitor element is housed in a case and filled with resin, and the first external connection terminal and the second external connection terminal are drawn out of the case.

### SUMMARY

A capacitor according to an aspect of the present disclosure includes a capacitor element, a frame body that surrounds the capacitor element and includes a pair of opening faces facing each other, and a first resin portion that is disposed inside the frame body and seals the capacitor element. The capacitor element is disposed between the pair of opening faces. The first resin portion is softer than the frame body.

A capacitor according to another aspect of the present disclosure includes a capacitor element, a frame body that surrounds the capacitor element and includes a pair of opening faces facing each other, and a first resin portion that is disposed inside the frame body and seals the capacitor element. The capacitor element is disposed between the pair of opening faces. The first resin portion is positioned more inner than at least one of the pair of opening faces.

A capacitor according to still another aspect of the present disclosure includes a capacitor element and a first resin portion that seals the capacitor element. The first resin portion includes a first surface and a second surface opposite to the first surface. The capacitor element is disposed between the first surface and the second surface. At least one of the first surface or the second surface is recessed toward the capacitor element except for an outer peripheral edge portion.

A capacitor according to still another aspect of the present disclosure includes a capacitor element, a case that houses the capacitor element and includes an opening face, a first resin portion that is disposed inside the case and seals the capacitor element, and a second resin portion that covers the first resin portion. The second resin portion protrudes outward from the opening face.

A capacitor according to still another aspect of the present disclosure includes a capacitor element, a case that houses the capacitor element and includes an opening face, and a first resin portion that is disposed inside the case and seals the capacitor element. The first resin portion protrudes outward from the opening face.

According to the present disclosure, even though a pressure is applied to bring the cooler into close contact with the resin, it is possible to prevent the pressure from being directly applied to the capacitor element.

### BRIEF DESCRIPTION OF THE DRAWINGS

FIG. 1 is a schematic sectional view illustrating a capacitor according to a first exemplary embodiment;

FIG. 2 is a schematic plan view illustrating the capacitor according to the first exemplary embodiment;

FIG. 3 is a schematic sectional view illustrating a capacitor according to a second exemplary embodiment;

FIG. 4 is a schematic sectional view illustrating a capacitor according to a third exemplary embodiment;

FIG. 5 is a schematic sectional view illustrating a capacitor according to a fourth exemplary embodiment;

FIG. 6 is a schematic sectional view illustrating a capacitor according to a fifth exemplary embodiment;

FIG. 7 is a schematic sectional view illustrating a capacitor according to a sixth exemplary embodiment;

FIG. 8 is a schematic sectional view illustrating a capacitor according to a seventh exemplary embodiment;

FIG. 9 is a schematic sectional view illustrating a capacitor according to an eighth exemplary embodiment;

FIG. 10 is a schematic sectional view illustrating a capacitor according to a ninth exemplary embodiment; and

FIG. 11 is a schematic sectional view illustrating a capacitor according to a tenth exemplary embodiment.

### DETAILED DESCRIPTIONS OF EMBODIMENTS

Hereinafter, problems in related art will be briefly described.

In the capacitor disclosed in Unexamined Japanese Patent Publication No. 2013-084787, the cooler is disposed on an outer surface of a case sidewall.

In this regard, from the viewpoint of heat dissipation, the inventors of the present invention have considered that it is more advantageous to bring the cooler into close contact with the resin filled in the case than to dispose the cooler on the outer surface of the case sidewall.

On the other hand, the inventors of the present invention have found that the above configuration brings the following problems. That is, in order to lower a thermal resistance of a contact portion between the cooler and the resin, the cooler needs to be pressed against the resin to some extent. However, when the cooler is pressed against the resin to be brought into close contact with the resin, the pressure thereof is directly transferred to the capacitor element, and the capacitor element may be damaged.

The present disclosure provides a capacitor capable of preventing a pressure from being directly applied to a capacitor element even though a pressure is applied to bring a cooler into close contact with the resin.

### Overview

Hereinafter, capacitor 1 according to the present exemplary embodiment will be described with reference to FIGS. 1 to 11. Each drawing is a schematic view, and a ratio of a size and a thickness of each component in each drawing does not necessarily reflect an actual dimensional ratio.

An arrow indicating each direction in each drawing is not intended to define a direction of capacitor 1 at the time of use, but is merely written for easy understanding of the description, and is not accompanied by entity.

In FIGS. 1 to 11, an X direction, a Y direction, and a Z direction of an orthogonal coordinate system are defined.

The X direction is a direction in which first electrode 21 and second electrode 22 of capacitor element 2 are arranged. The X direction may be referred to as a "left-right direction". That is, a -X direction may referred to as "left", and a +X direction may be referred to as "right".

The Y direction may be referred to as a "front-back direction". That is, a +Y direction may be referred to as "front", and a -Y direction may be referred to as "back".

The Z direction is a direction in which first surface portion 41 and second surface portion 42 of first resin portion 4 are arranged. The Z direction may be referred to as an "up-down direction". That is, a +Z direction may be referred to as "up" and a -Z direction may be referred to as "down". Viewing an object from above may be referred to as "plan view".

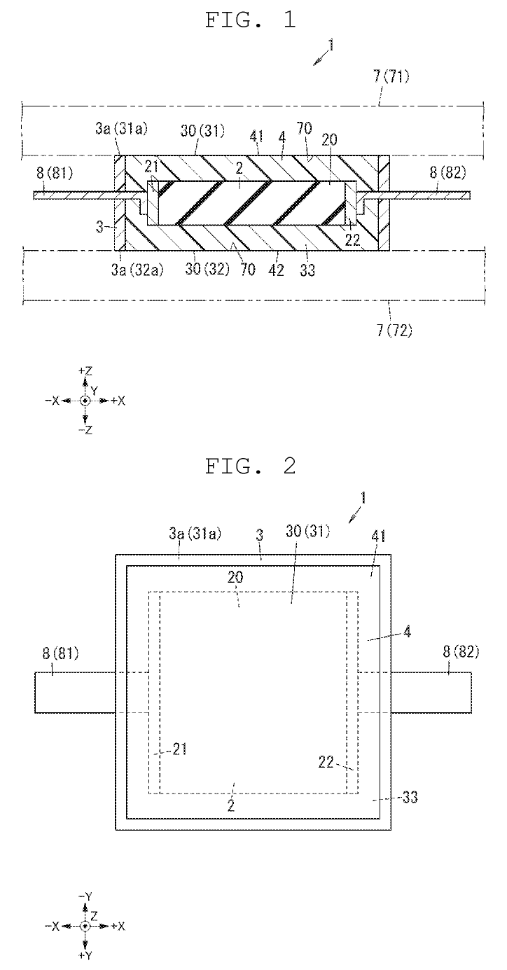

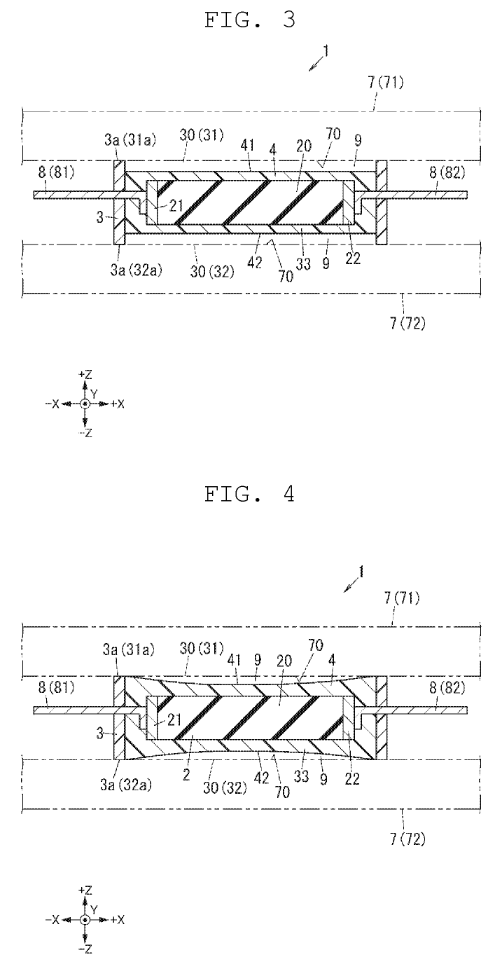

That is, capacitor 1 according to the present exemplary embodiment includes capacitor element 2, frame body 3, and first resin portion 4, as illustrated in FIGS. 1 and 2. Frame body 3 includes a pair of opening faces 30 facing each other, and surrounds capacitor element 2. Capacitor element 2 is disposed between the pair of opening faces 30. First resin portion 4 is disposed inside frame body 3 and seals capacitor element 2. First resin portion 4 is softer than frame body 3.

As illustrated in FIG. 1, even though a pressing force further increases in a state where first cooler 71 abuts on first opening edge portion 31a of frame body 3, a pressure applied to first resin portion 4 can be reduced because first resin portion 4 is softer than frame body 3. Similarly, even though a pressing force further increases in a state where second cooler 72 abuts on second opening edge portion 32a of frame body 3, the pressure applied to first resin portion 4 can be reduced because first resin portion 4 is softer than frame body 3.

Thus, according to the present exemplary embodiment, even though a pressure is applied to bring cooler 7 into close contact with the resin, it is possible to prevent the pressure from being directly applied to capacitor element 2. As a result, damage to capacitor element 2 can be suppressed.

### Details

### First exemplary embodiment

Hereinafter, capacitor 1 according to the first exemplary embodiment will be described with reference to FIGS. 1 and 2.

Capacitor 1 according to the first exemplary embodiment includes capacitor element 2, frame body 3, and first resin portion 4.

### Capacitor element

Capacitor element 2 is not particularly limited, and examples thereof include a film capacitor element and an electrolytic capacitor element.

Specifically, capacitor element 2 includes element body 20, first electrode 21, and second electrode 22.

A shape of element body 20 is not particularly limited, but in the first exemplary embodiment, the element body has a substantially rectangular parallelepiped shape that is flat in a plane perpendicular to the up-down direction. Although not illustrated, in element body 20, a first internal electrode and a second internal electrode face each other with a dielectric interposed therebetween.

First electrode 21 is provided on a left end face of element body 20. First electrode 21 is electrically connected to the first internal electrode.

Meanwhile, second electrode 22 is provided on a right end face of element body 20. Second electrode 22 is electrically connected to the second internal electrode.

### Frame body

A shape of frame body 3 is not particularly limited, but in the first exemplary embodiment, the frame body has a rectangular shape in plan view (see FIG. 2). Frame body 3 is slightly larger than capacitor element 2 in plan view.

Frame body 3 includes the pair of opening faces 30. Each of the pair of opening faces 30 is a flat area surrounded by opening edge portion 3a of frame body 3. Specifically, the pair of opening faces 30 are first opening face 31 and second opening face 32. First opening face 31 is a flat area surrounded by first opening edge portion 31a of frame body 3. Meanwhile, second opening face 32 is a flat area surrounded by second opening edge portion 32a of frame body 3.

The pair of opening faces 30 faces each other. Specifically, first opening face 31 and second opening face 32 face each other in the up-down direction. A distance between first opening face 31 and second opening face 32 corresponds to a height of frame body 3. The height of frame body 3 is greater than a thickness (height in the up-down direction) of capacitor element 2 (see FIG. 1).

Frame body 3 includes housing portion 33. Housing portion 33 is a space surrounded by an inner surface of frame body 3 and the pair of opening faces 30. Capacitor element 2 is housed in housing portion 33. As described above, frame body 3 surrounds capacitor element 2 between the pair of opening faces 30.

A material of frame body 3 is not particularly limited, and examples thereof include polyphenylene sulfide (PPS).

Hardness of frame body 3 can be defined by Young's modulus. Specifically, the Young's modulus of frame body 3 ranges, for example, from 1 GPa to 25 GPa, inclusive.

### First resin portion

First resin portion 4 is a cured product of a thermosetting resin. The resin is not particularly limited, and examples thereof include an epoxy resin (EP).

First resin portion 4 seals capacitor element 2. That is, capacitor element 2 is buried in first resin portion 4.

First resin portion 4 is disposed inside frame body 3. In the first exemplary embodiment, first resin portion 4 is filled in an inside (housing portion 33) of frame body 3. Specifically, a portion of housing portion 33 excluding capacitor element 2 and bus bars 8 (to be described later) is filled with first resin portion 4.

First resin portion 4 includes first surface portion 41 and second surface portion 42.

First surface portion 41 is an upper surface. In the first exemplary embodiment, first surface portion 41 is flush with first opening face 31. That is, first surface portion 41, first opening face 31, and first opening edge portion 31a are present on an identical plane.

Meanwhile, second surface portion 42 is a surface opposite to first surface portion 41. That is, second surface portion 42 is a lower surface. In the first exemplary embodiment, second surface portion 42 is flush with second opening face 32. That is, second surface portion 42, second opening face 32, and second opening edge portion 32a are present on an identical plane.

First resin portion 4 is softer than frame body 3. Hardness of first resin portion 4 can also be defined by Young's modulus. That is, the Young's modulus of first resin portion 4 is smaller than the Young's modulus of frame body 3. Specifically, the Young's modulus of first resin portion 4 ranges, for example, from 1 MPa to 5 GPa, inclusive.

### Cooler

Capacitor 1 according to the first exemplary embodiment further includes cooler 7. Cooler 7 is not particularly limited, and examples thereof include a heat sink. A heat spreader may be combined with the heat sink.

A shape of cooler 7 is not particularly limited, but is a plate shape in the first exemplary embodiment. Cooler 7 includes flat face 70. Cooler 7 may include a fin structure.

A material of cooler 7 is not particularly limited, and examples thereof include aluminum, copper, and like.

Cooler 7 faces opening face 30, and comes into contact with frame body 3 and first resin portion 4 while pressing frame body 3 and first resin portion 4 in a direction toward capacitor element 2.

Specifically, in the first exemplary embodiment, cooler 7 includes first cooler 71 and second cooler 72.

First cooler 71 faces first opening face 31, and comes into contact with frame body 3 and first resin portion 4 while pressing first opening edge portion 31a of frame body 3 and first surface portion 41 of first resin portion 4 in a direction toward capacitor element 2 (that is, downward). Flat face 70 of first cooler 71 comes into close contact with first opening edge portion 31a of frame body 3 and first surface portion 41 of first resin portion 4.

Meanwhile, second cooler 72 faces second opening face 32, and comes into contact with frame body 3 and first resin portion 4 while pressing second opening edge portion 32a of frame body 3 and second surface portion 42 of first resin portion 4 in a direction toward capacitor element 2 (that is, upward). Flat face 70 of second cooler 72 comes into close contact with second opening edge portion 32a of frame body 3 and second surface portion 42 of first resin portion 4.

### Bus bar

Capacitor 1 according to the first exemplary embodiment further includes bus bars 8. Bus bar 8 is a conductor. A shape of bus bar 8 is not particularly limited, but is, for example, a plate shape or a rod shape. A material of bus bar 8 is not particularly limited, and examples thereof include copper, aluminum, and like.

Bus bars 8 include first bus bar 81 and second bus bar 82. First bus bar 81 is connected to first electrode 21. First bus bar 81 penetrates first resin portion 4 and frame body 3, and extends to an outside of frame body 3 (left side of frame body 3). Meanwhile, second bus bar 82 is connected to second electrode 22. Second bus bar 82 also penetrates first resin portion 4 and frame body 3, and extends to the outside (right side) of frame body 3. Note that, the number, positions, and extending directions of bus bars 8 are not particularly limited.

### Operations and effects

When first cooler 71 is pressed against first surface portion 41 of first resin portion 4, a thermal resistance of a contact portion between flat face 70 and first surface portion 41 can be reduced. Similarly, when second cooler 72 is pressed against second surface portion 42 of first resin portion 4, a thermal resistance of a contact portion between flat face 70 and second surface portion 42 can be reduced. Consequently, heat generated in capacitor element 2 easily escapes to the outside through first resin portion 4, first cooler 71, and second cooler 72. That is, the heat dissipation of capacitor 1 can be enhanced.

Meanwhile, even though a pressing force further increases in a state where first cooler 71 abuts on first opening edge portion 31a of frame body 3, a pressure applied to first resin portion 4 can be reduced because first resin portion 4 is softer than frame body 3. Similarly, even though a pressing force further increases in a state where second cooler 72 abuts on second opening edge portion 32a of frame body 3, the pressure applied to first resin portion 4 can be reduced because first resin portion 4 is softer than frame body 3.

Thus, according to the first exemplary embodiment, even though the pressure is applied to bring cooler 7 into close contact with the resin, it is possible to prevent the pressure from being directly applied to capacitor element 2. As a result, damage to capacitor element 2 can be suppressed.

### Second exemplary embodiment

Capacitor 1 according to a second exemplary embodiment will be described with reference to FIG. 3. In the second exemplary embodiment, components similar to those in the first exemplary embodiment are denoted by the same reference numerals as those in the first exemplary embodiment, and details of the components may not be described.

The second exemplary embodiment is different from the first exemplary embodiment in a configuration of first resin portion 4. Hereinafter, differences will be mainly described.

### First resin portion

First resin portion 4 is positioned more inner than at least one of the pair of opening faces 30 (both of the pair of opening faces 30 in the second exemplary embodiment).

Specifically, first surface portion 41 of first resin portion 4 is positioned more inner than first opening face 31 (below first opening face 31). That is, first surface portion 41 and first opening face 31 are not present on an identical plane. Thus, gap 9 may be formed between first surface portion 41 and flat face 70 of first cooler 71. A thermal interface material to be described later is disposed in gap 9.

Meanwhile, second surface portion 42 of first resin portion 4 is positioned more inner than second opening face 32 (above second opening face 32). That is, second surface portion 42 and second opening face 32 are not present on an identical plane. Thus, gap 9 may be formed between second surface portion 42 and flat face 70 of second cooler 72. A thermal interface material to be described later is also disposed in gap 9.

### Thermal interface material (TIM)

The thermal interface material is not particularly limited, and examples thereof include a thermally conductive grease, a thermally conductive sheet, a phase change material (PCM), a thermally conductive gel, a thermally conductive adhesive, and a thermally conductive tape.

Examples of the thermally conductive grease include silicone-based thermally conductive grease. Examples of the thermally conductive sheet include a silicone-based thermally conductive sheet. Examples of the thermally conductive gel include a silicone gel. Examples of the thermally conductive adhesive include an epoxy-based thermally conductive adhesive.

### Cooler

Cooler 7 faces opening face 30, and comes into contact with at least one of frame body 3 or first resin portion 4 while pressing at least one of frame body 3 or first resin portion 4 in a direction toward capacitor element 2.

Specifically, first cooler 71 faces first opening face 31, and comes into contact with frame body 3 while pressing first opening edge portion 31a of frame body 3 in a direction toward capacitor element 2 (that is, downward). Flat face 70 of first cooler 71 comes into close contact with first opening edge portion 31a of frame body 3 and a thermal interface material (not illustrated) disposed in gap 9.

Meanwhile, second cooler 72 faces second opening face 32, and comes into contact with frame body 3 while pressing second opening edge portion 32a of frame body 3 in a direction toward capacitor element 2 (that is, upward). Flat face 70 of second cooler 72 comes into close contact with second opening edge portion 32a of frame body 3 and a thermal interface material (not illustrated) disposed in gap 9.

### Operations and effects

The second exemplary embodiment also achieves operations and effects substantially similar to those in the first exemplary embodiment. In particular, in the second exemplary embodiment, a pressure applied to first resin portion 4 by cooler 7 via the thermal interface material can be reduced.

Thus, according to the second exemplary embodiment, even though the pressure is applied to bring cooler 7 into close contact with the resin, it is possible to prevent the pressure from being directly applied to capacitor element 2. As a result, damage to capacitor element 2 can be suppressed.

### Third exemplary embodiment

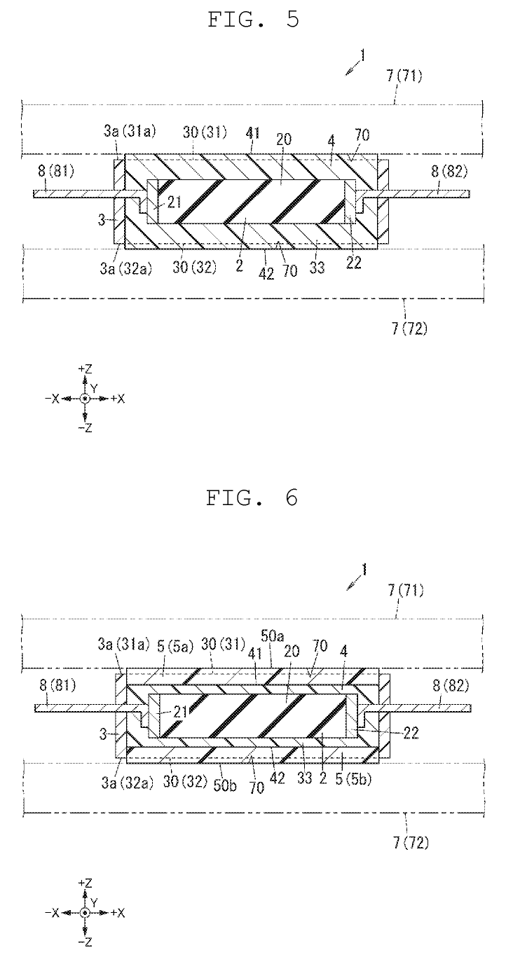

Capacitor 1 according to a third exemplary embodiment will be described with reference to FIG. 4. In the third exemplary embodiment, components similar to those in the first and second exemplary embodiments are denoted by the same reference numerals as those in the first and second exemplary embodiments, and a detailed description thereof may be omitted.

The third exemplary embodiment is different from the first and second exemplary embodiments in a configuration of first resin portion 4. Hereinafter, differences will be mainly described.

### First resin portion

First surface portion 41 and second surface portion 42 are each formed into a concave surface. That is, a center of each of first surface portion 41 and second surface portion 42 is gently recessed toward capacitor element 2. Thus, gap 9 can be formed between first surface portion 41 and flat face 70 of first cooler 71. Similarly, gap 9 can be formed between second surface portion 42 and flat face 70 of second cooler 72. The thermal interface material described above is disposed in gap 9 therebetween.

### Operations and effects

The third exemplary embodiment also achieves operations and effects substantially similar to those in the second exemplary embodiment.

### Fourth exemplary embodiment

Capacitor 1 according to a fourth exemplary embodiment will be described with reference to FIG. 5. In the fourth exemplary embodiment, components similar to those in the first to third exemplary embodiments are denoted by the same reference numerals as those in the first to third exemplary embodiments, and a detailed description thereof may be omitted.

The fourth exemplary embodiment is different from the first to third exemplary embodiment in a configuration of first resin portion 4. Hereinafter, differences will be mainly described.

### First resin portion

A part of first resin portion 4 is positioned outside at least one of the pair of opening faces 30 (both of the pair of opening faces 30 in the fourth exemplary embodiment).

Specifically, first surface portion 41 of first resin portion 4 is positioned outside first opening face 31 (above first opening face 31). As described above, first surface portion 41 and first opening face 31 are not present on an identical plane. That is, a part of first resin portion 4 protrudes upward from first opening face 31.

Meanwhile, second surface portion 42 of first resin portion 4 is positioned outside second opening face 32 (below second opening face 32). As described above, second surface portion 42 and second opening face 32 are not present on an identical plane. That is, a part of first resin portion 4 protrudes downward from second opening face 32.

### Cooler

Cooler 7 faces opening face 30, and comes into contact with first resin portion 4 while pressing first resin portion 4 in a direction toward capacitor element 2.

Specifically, first cooler 71 faces first opening face 31, and comes into contact with first resin portion 4 while pressing first surface portion 41 of first resin portion 4 in a direction toward capacitor element 2 (that is, downward). Flat face 70 of first cooler 71 comes into close contact with first surface portion 41. Note that, depending on the pressing force, flat face 70 of first cooler 71 may also be brought into close contact with first opening edge portion 31a of frame body 3.

Meanwhile, second cooler 72 faces second opening face 32, and comes into contact with first resin portion 4 while pressing second surface portion 42 of first resin portion 4 in a direction toward capacitor element 2 (that is, upward). Flat face 70 of second cooler 72 comes into close contact with second surface portion 42. Note that, depending on the pressing force, flat face 70 of second cooler 72 may also be brought into close contact with second opening edge portion 32a of frame body 3.

### Operations and effects

In the fourth exemplary embodiment, the heat dissipation of capacitor 1 can also be enhanced as in the first exemplary embodiment (FIG. 1).

In particular, in the fourth exemplary embodiment, when first cooler 71 is pressed against first surface portion 41 of first resin portion 4, first resin portion 4 is deformed, and thus, the pressure applied to first resin portion 4 can be reduced. Similarly, when second cooler 72 is pressed against second surface portion 42 of first resin portion 4, first resin portion 4 is deformed, and thus, the pressure applied to first resin portion 4 can be reduced.

Even though the pressing force further increases in a state where first cooler 71 abuts on first opening edge portion 31a of frame body 3, the pressure applied to first resin portion 4 can be reduced because first resin portion 4 is softer than frame body 3. Similarly, even though a pressing force further increases in a state where second cooler 72 abuts on second opening edge portion 32a of frame body 3, the pressure applied to first resin portion 4 can be reduced because first resin portion 4 is softer than frame body 3.

Thus, according to the fourth exemplary embodiment, even though the pressure is applied to bring cooler 7 into close contact with the resin, it is possible to prevent the pressure from being directly applied to capacitor element 2. As a result, damage to capacitor element 2 can be suppressed.

### Fifth exemplary embodiment

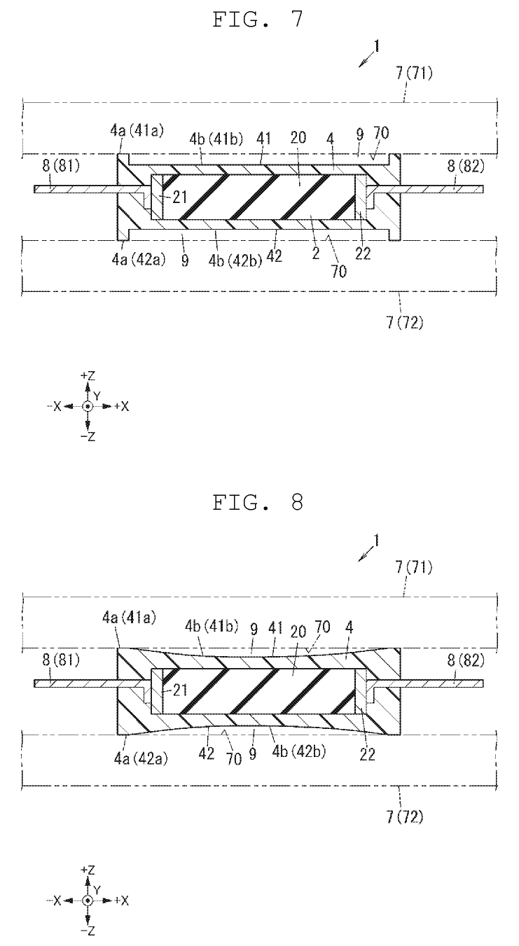

Capacitor 1 according to a fifth exemplary embodiment will be described with reference to FIG. 6. In the fifth exemplary embodiment, components similar to those in the first to fourth exemplary embodiments are denoted by the same reference numerals as those in the first to fourth exemplary embodiments, and a detailed description thereof may be omitted.

The fifth exemplary embodiment is different from the first to fourth exemplary embodiment in a configuration that capacitor 1 further includes second resin portion 5. Hereinafter, differences will be mainly described.

### Second resin portion

Second resin portions 5 are positioned closer to at least one of the pair of opening faces 30 (both of the pair of opening faces 30 in the fifth exemplary embodiment) than first resin portion 4, and cover first resin portion 4.

Specifically, in the fifth exemplary embodiment, second resin portions 5 are disposed at two places of capacitor 1. Second resin portions 5 disposed at two places are distinguished as "second resin portion 5a" and "second resin portion 5b".

Second resin portion 5a covers a surface (first surface portion 41) of first resin portion 4 close to first opening face 31. Specifically, second resin portion 5a fills a space surrounded by the inner surface of frame body 3, first surface portion 41 of first resin portion 4, and first opening face 31. Further, a part of second resin portion 5a protrudes upward from first opening face 31.

Meanwhile, second resin portion 5b covers a surface (second surface portion 42) of first resin portion 4 close to second opening face 32. Specifically, second resin portion 5b fills a space surrounded by the inner surface of frame body 3, second surface portion 42 of first resin portion 4, and second opening face 32. Further, a part of second resin portion 5b protrudes downward from second opening face 32.

As described above, parts of second resin portions 5 ("a part of second resin portion 5a" and "a part of second resin portion 5b" in the fifth exemplary embodiment) protrude outward from at least one of the pair of opening faces 30 (both of the pair of opening faces 30 in the fifth exemplary embodiment).

Specifically, second resin portion 5a includes flat face 50a facing upward. The "part of second resin portion 5a" is a portion from first opening face 31 to flat face 50a. Meanwhile, second resin portion 5b includes flat face 50a facing downward. The "part of second resin portion 5b" is a portion from second opening face 32 to flat face 50b.

Second resin portion 5 is a cured product of a thermosetting resin. The thermosetting resin is not particularly limited, and examples thereof include polyurethane (PUR).

Second resin portion 5 is softer than first resin portion 4. As described above, second resin portion 5 is the softest among frame body 3, first resin portion 4, and second resin portion 5. Hardness of second resin portion 5 can also be defined by Young's modulus. That is, the Young's modulus of second resin portion 5 is smaller than the Young's modulus of first resin portion 4, and is the smallest among the Young's moduli of frame body 3, first resin portion 4, and second resin portion 5. Specifically, the Young's modulus of second resin portion 5 ranges, for example, from 0.1 MPa to 500 MPa, inclusive.

### Cooler

Cooler 7 comes into contact with second resin portion 5 while pressing second resin portion 5 in a direction toward capacitor element 2.

Specifically, first cooler 71 comes into contact with second resin portion 5a while pressing flat face 50a of second resin portion 5a in a direction toward capacitor element 2 (that is, downward). As described above, flat face 70 of first cooler 71 comes into close contact with flat face 50a. Note that, depending on the pressing force, flat face 70 of first cooler 71 may also be brought into close contact with first opening edge portion 31a of frame body 3.

Meanwhile, second cooler 72 comes into contact with second resin portion 5b while pressing flat face 50b of second resin portion 5b in a direction toward capacitor element 2 (that is, upward). As described above, flat face 70 of second cooler 72 comes into close contact with flat face 50b. Note that, depending on the pressing force, flat face 70 of second cooler 72 may also be brought into close contact with second opening edge portion 32a of frame body 3.

### Operations and effects

When first cooler 71 is pressed against flat face 50a of second resin portion 5a, a thermal resistance of a contact portion between flat face 70 and flat face 50a can be reduced. Similarly, when second cooler 72 is pressed against flat face 50b of second resin portion 5b, a thermal resistance of a contact portion between flat face 70 and flat face 50b can be reduced. Consequently, heat generated in capacitor element 2 easily escapes to the outside through first resin portion 4, second resin portion 5, first cooler 71, and second cooler 72. That is, the heat dissipation of capacitor 1 can be enhanced.

Meanwhile, in the fifth exemplary embodiment, when first cooler 71 is pressed against flat face 50a of second resin portion 5a, second resin portion 5a is deformed, and thus, a pressure applied to second resin portion 5a can be reduced. Similarly, when second cooler 72 is pressed against flat face 50b of second resin portion 5b, first resin portion 4 is deformed, and thus, the pressure applied to first resin portion 4 can be reduced.

Even though the pressing force further increases in a state where first cooler 71 abuts on first opening edge portion 31a of frame body 3, a pressure applied to first resin portion 4 and second resin portion 5 can be reduced because first resin portion 4 and second resin portion 5 are softer than frame body 3. Similarly, even though the pressing force further increases in a state where second cooler 72 abuts on second opening edge portion 32a of frame body 3, the pressure applied to first resin portion 4 and second resin portion 5 can be reduced because first resin portion 4 and second resin portion 5 are softer than frame body 3.

Thus, according to the fifth exemplary embodiment, a pressure applied to capacitor element 2 can be reduced by second resin portion 5. As a result, damage to capacitor element 2 can be suppressed.

Moreover, since first resin portion 4 that seals capacitor element 2 is harder than second resin portion 5, moisture is less likely to pass through first resin portion 4. Thus, a sealing effect can be enhanced.

### Sixth exemplary embodiment

Capacitor 1 according to a sixth exemplary embodiment will be described with reference to FIG. 7. In the sixth exemplary embodiment, components similar to those in the first to fifth exemplary embodiments are denoted by the same reference numerals as those in the first to fifth exemplary embodiments, and a detailed description thereof may be omitted.

Capacitor 1 according to the sixth exemplary embodiment is different from capacitors 1 according to the first to fifth exemplary embodiments in a configuration that a component corresponding to frame bodies 3 of the first to fifth exemplary embodiments is not provided. Hereinafter, differences will be mainly described.

### First resin portion

First resin portion 4 seals capacitor element 2, and capacitor element 2 is disposed between first surface portion 41 and second surface portion 42.

At least one of first surface portion 41 or second surface portion 42 (both first surface portion 41 and second surface portion 42 in the sixth exemplary embodiment) is recessed toward capacitor element 2 except for outer peripheral edge portion 4a.

Each of first surface portion 41 and second surface portion 42 includes outer peripheral edge portion 4a and principal surface portion 4b. Hereinafter, outer peripheral edge portion 4a and principal surface portion 4b of first surface portion 41 may be referred to as "first outer peripheral edge portion 41a" and "first principal surface portion 41b", respectively. Further, outer peripheral edge portion 4a and principal surface portion 4b of second surface portion 42 may be referred to as "second outer peripheral edge portion 42a" and "second principal surface portion 42b", respectively.

Although not illustrated, first outer peripheral edge portion 41a is provided so as to surround first principal surface portion 41b in plan view. Further, in a direction perpendicular to first surface portion 41 (first principal surface portion 41b), first outer peripheral edge portion 41a is positioned outside first principal surface portion 41b (above first principal surface portion 41b). That is, first principal surface portion 41b is a portion recessed (downward) toward capacitor element 2. Thus, gap 9 can be formed between first principal surface portion 41b and flat face 70 of first cooler 71. The thermal interface material described above is disposed in gap 9.

Meanwhile, second outer peripheral edge portion 42a is also provided so as to surround second principal surface portion 42b in plan view. Further, in a direction perpendicular to second surface portion 42 (second principal surface portion 42b), second outer peripheral edge portion 42a is positioned outside second principal surface portion 42b (below second principal surface portion 42b). That is, second principal surface portion 42b is a portion recessed (upward) toward capacitor element 2. Thus, gap 9 can be formed between second principal surface portion 42b and flat face 70 of second cooler 72. The thermal interface material described above is disposed in gap 9.

### Cooler

Cooler 7 comes into contact with first resin portion 4 while pressing first resin portion 4 in a direction toward capacitor element 2.

Specifically, first cooler 71 comes into contact with first resin portion 4 while pressing first outer peripheral edge portion 41a of first resin portion 4 in a direction toward capacitor element 2 (that is, downward). Flat face 70 of first cooler 71 comes into close contact with first outer peripheral edge portion 41a and the thermal interface material (not illustrated) disposed in gap 9.

Meanwhile, second cooler 72 comes into contact with first resin portion 4 while pressing second outer peripheral edge portion 42a of first resin portion 4 in a direction toward capacitor element 2 (that is, upward). Flat face 70 of second cooler 72 comes into close contact with second outer peripheral edge portion 42a and the thermal interface material (not illustrated) disposed in gap 9.

### Operations and effects

When the pressing force further increases in a state where first cooler 71 abuts on first outer peripheral edge portion 41a of first resin portion 4, first outer peripheral edge portion 41a is deformed, and thus, a pressure applied to first principal surface portion 41b of first resin portion 4 can be reduced. Similarly, when the pressing force further increases in a state where second cooler 72 abuts on second outer peripheral edge portion 42a of first resin portion 4, second outer peripheral edge portion 42a is deformed, and thus, a pressure applied to second principal surface portion 42b of first resin portion 4 can be reduced.

Thus, according to the sixth exemplary embodiment, even though the pressure is applied to bring cooler 7 into close contact with the resin, it is possible to prevent the pressure from being directly applied to capacitor element 2.

### Damage to capacitor element 2 can be suppressed.

### Seventh exemplary embodiment

Capacitor 1 according to a seventh exemplary embodiment will be described with reference to FIG. 8. In the seventh exemplary embodiment, components similar to those in the first to sixth exemplary embodiments are denoted by the same reference numerals as those in the first to sixth exemplary embodiments, and a detailed description thereof may be omitted.

As in the sixth exemplary embodiment, capacitor 1 according to the seventh exemplary embodiment is different from capacitors 1 according to the first to fifth exemplary embodiments in a configuration that a component corresponding to frame bodies 3 of the first to fifth exemplary embodiments is not provided. Further, the seventh exemplary embodiment is different from the sixth exemplary embodiment in a configuration of principal surface portion 4b of first resin portion 4. Hereinafter, differences will be mainly described.

### First resin portion

Each of first principal surface portion 41b of first surface portion 41 and second principal surface portion 42b of second surface portion 42 is a concave surface. That is, a center of each of first principal surface portion 41b of first surface portion 41 and second principal surface portion 42b of second surface portion 42 is gently recessed toward capacitor element 2. Thus, gap 9 can be formed between first principal surface portion 41b of first surface portion 41 and flat face 70 of first cooler 71. Similarly, gap 9 can be formed between second principal surface portion 42b of second surface portion 42 and flat face 70 of second cooler 72. The thermal interface material described above is disposed in gap 9 therebetween.

### Operations and effects

The seventh exemplary embodiment also achieves operations and effects substantially similar to those in the sixth exemplary embodiment.

### Eighth exemplary embodiment

Capacitor 1 according to an eighth exemplary embodiment will be described with reference to FIG. 9. In the eighth exemplary embodiment, components similar to those in the first to seventh exemplary embodiments are denoted by the same reference numerals as those in the first to seventh exemplary embodiments, and a detailed description thereof may be omitted.

Capacitor 1 according to the eighth exemplary embodiment is different from capacitors 1 according to the first to fifth exemplary embodiments in a configuration that a component corresponding to frame bodies 3 of the first to fifth exemplary embodiments is not provided, as in the sixth and seventh exemplary embodiments. Further, the eighth exemplary embodiment is different from the sixth exemplary embodiment (FIG. 7) in a configuration that capacitor 1 further includes second resin portions 5.

### Second resin portion

Second resin portions 5 cover at least one of first surface portion 41 or second surface portion 42 (both first surface portion 41 and second surface portion 42 in the eighth exemplary embodiment).

Specifically, second resin portion 5a covers first principal surface portion 41b of first resin portion 4. Meanwhile, second resin portion 5b covers second principal surface portion 42b of first resin portion 4.

Further, in a direction perpendicular to at least one of first surface portion 41 or second surface portion 42, each of parts of second resin portions 5 (each of "a part of second resin portion 5a" and "a part of second resin portion 5b" in the eighth exemplary embodiment) protrudes outward from outer peripheral edge portion 4a.

Specifically, the "part of second resin portion 5a" is a portion from virtual plane P1 including first outer peripheral edge portion 41a to flat face 50a. Meanwhile, the "part of second resin portion 5b" is a portion from virtual plane P2 including second outer peripheral edge portion 42a to flat face 50b.

In the eighth exemplary embodiment, second resin portion 5 is softer than first resin portion 4 as in the fifth exemplary embodiment. That is, the Young's modulus of second resin portion 5 is smaller than the Young's modulus of first resin portion 4. The material and Young's modulus of second resin portion 5 are as described above.

### Cooler

Cooler 7 comes into contact with second resin portion 5 while pressing second resin portion 5 in a direction toward capacitor element 2.

Specifically, first cooler 71 comes into contact with second resin portion 5a while pressing flat face 50a of second resin portion 5a in a direction toward capacitor element 2 (that is, downward). As described above, flat face 70 of first cooler 71 comes into close contact with flat face 50a. Note that, depending on the pressing force, flat face 70 of first cooler 71 may also be brought into close contact with first outer peripheral edge portion 41a of first resin portion 4.

Meanwhile, second cooler 72 comes into contact with second resin portion 5b while pressing flat face 50b of second resin portion 5b in a direction toward capacitor element 2 (that is, upward). As described above, flat face 70 of second cooler 72 comes into close contact with flat face 50b. Note that, depending on the pressing force, flat face 70 of second cooler 72 may also be brought into close contact with second outer peripheral edge portion 42a of first resin portion 4.

### Operations and effects

In the eighth exemplary embodiment, the heat dissipation of capacitor 1 can also be enhanced as in the fifth exemplary embodiment (FIG. 6).

Meanwhile, in the eighth exemplary embodiment, when first cooler 71 is pressed against flat face 50a of second resin portion 5a, second resin portion 5a is deformed, and thus, a pressure applied to second resin portion 5a can be reduced. Similarly, when second cooler 72 is pressed against flat face 50b of second resin portion 5b, first resin portion 4 is deformed, and thus, the pressure applied to first resin portion 4 can be reduced.

Even though the pressing force further increases in a state where first cooler 71 abuts on first outer peripheral edge portion 41a of first resin portion 4, the pressure applied to second resin portion 5 can be reduced because second resin portion 5 is softer than first resin portion 4. Similarly, even though the pressing force further increases in a state where second cooler 72 abuts on second outer peripheral edge portion 42a of first resin portion 4, the pressure applied to second resin portion 5 can be reduced because second resin portion 5 is softer than first resin portion 4.

Thus, according to the eighth exemplary embodiment, the pressure applied to capacitor element 2 can be reduced by second resin portion 5. As a result, damage to capacitor element 2 can be suppressed.

### Ninth exemplary embodiment

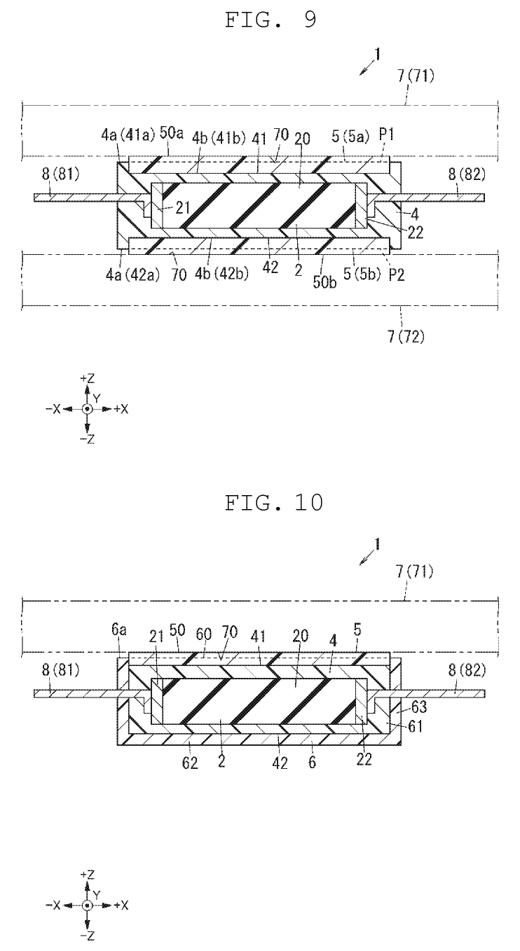

Capacitor 1 according to a ninth exemplary embodiment will be described with reference to FIG. 10. In the ninth exemplary embodiment, components similar to those in the first to eighth exemplary embodiments are denoted by the same reference numerals as those in the first to eighth exemplary embodiments, and a detailed description thereof may be omitted.

Capacitor 1 according to the ninth exemplary embodiment is different from capacitors 1 according to the first to fifth exemplary embodiments in a configuration that case 6 is provided instead of the component corresponding to frame bodies 3 of the first to fifth exemplary embodiments. Hereinafter, differences will be mainly described.

### Case

A shape of case 6 is not particularly limited. Although not illustrated, in the ninth exemplary embodiment, case 6 has a rectangular shape in plan view. Further, case 6 is slightly larger than capacitor element 2 in planar view.

Case 6 includes bottom plate portion 62 and peripheral wall portion 63. Peripheral wall portion 63 extends upward from an outer periphery of bottom plate portion 62. An upper end of peripheral wall portion 63 is opening edge portion 6a. A flat area surrounded by opening edge portion 6a is opening face 60. A space surrounded by bottom plate portion 62, peripheral wall portion 63, and opening face 60 is housing portion 61. Capacitor element 2 is housed in housing portion 61. As described above, case 6 includes opening face 60, and houses capacitor element 2.

### First resin portion

As in the fifth exemplary embodiment (FIG. 6), first resin portion 4 seals capacitor element 2. That is, capacitor element 2 is buried in first resin portion 4.

First resin portion 4 is disposed inside case 6. In the ninth exemplary embodiment, an inside of case 6 (housing portion 61) is filled with first resin portion 4. Specifically, a portion of housing portion 61 excluding capacitor element 2 and bus bar 8 is filled with first resin portion 4.

First resin portion 4 is positioned more inner than opening face 60. Specifically, first surface portion 41 of first resin portion 4 is positioned more inner than opening face 60 (below opening face 60). That is, first surface portion 41 and opening face 60 are not present on an identical plane.

First resin portion 4 is softer than case 6. Hardness of case 6 can also be defined by Young's modulus. That is, the Young's modulus of first resin portion 4 is smaller than the Young's modulus of case 6. Specifically, the Young's modulus of case 6 ranges, for example, from 1 GPa to 25 GPa, inclusive.

### Second resin portion

Second resin portion 5 covers first resin portion 4. Specifically, second resin portion 5 fills a space surrounded by an inner surface of peripheral wall portion 63 of case 6, first surface portion 41 of first resin portion 4, and opening face 60. Further, a part of second resin portion 5 protrudes outward (upward) from opening face 60.

Second resin portion 5 is softer than first resin portion 4. As described above, second resin portion 5 is the softest among case 6, first resin portion 4, and second resin portion 5. That is, the Young's modulus of second resin portion 5 is smaller than the Young's modulus of first resin portion 4, and is the smallest among the Young's moduli of case 6, first resin portion 4, and second resin portion 5.

### Cooler

Cooler 7 comes into contact with second resin portion 5 while pressing second resin portion 5 against capacitor element 2.

Specifically, cooler 7 comes into contact with second resin portion 5 while pressing flat face 50 of second resin portion 5 toward capacitor element 2 (that is, downward). As described above, flat face 70 of cooler 7 comes into close contact with flat face 50. Note that, depending on the pressing force, flat face 70 of cooler 7 may also be brought into close contact with opening edge portion 6a of case 6.

### Bus bar

In the ninth exemplary embodiment, first bus bar 81 penetrates first resin portion 4 and peripheral wall portion 63, and extends to an outside of case 6 (left side of peripheral wall portion 63 of case 6). Meanwhile, second bus bar 82 also penetrates first resin portion 4 and peripheral wall portion 63, and extends to the outside of case 6 (right side of peripheral wall portion 63 of case 6). Note that, bus bar 8 may penetrate bottom plate portion 62.

### Operations and effects

As in the fifth exemplary embodiment (FIG. 6), the ninth exemplary embodiment can also improve the heat dissipation of capacitor 1.

Meanwhile, in the ninth exemplary embodiment, when cooler 7 is pressed against flat face 50 of second resin portion 5, second resin portion 5 is deformed, and thus, the pressure applied to second resin portion 5 can be reduced.

Even though the pressing force further increases in a state where cooler 7 abuts on opening edge portion 6a of case 6, the pressure applied to second resin portion 5 can be reduced because second resin portion 5 is softer than first resin portion 4 and case 6.

Thus, according to the ninth exemplary embodiment, even though the pressure is applied to bring cooler 7 into close contact with the resin, it is possible to prevent the pressure from being directly applied to capacitor element 2. As a result, damage to capacitor element 2 can be suppressed.

### Tenth exemplary embodiment

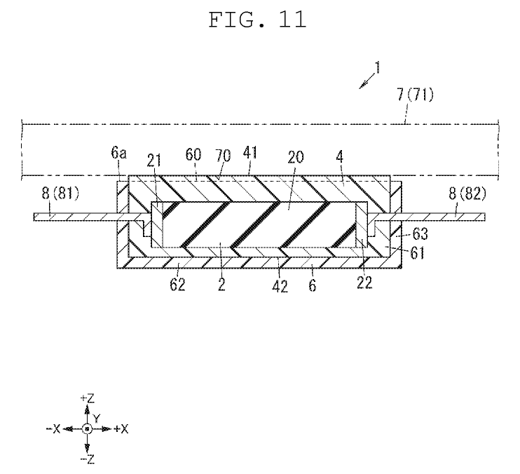

Capacitor 1 according to a tenth exemplary embodiment will be described with reference to FIG. 11. In the tenth exemplary embodiment, components similar to those in the first to ninth exemplary embodiments are denoted by the same reference numerals as those in the first to ninth exemplary embodiments, and a detailed description thereof may be omitted.

As in the ninth exemplary embodiment, capacitor 1 according to the tenth exemplary embodiment is different from capacitors 1 according to the first to fifth exemplary embodiments in a configuration that case 6 is provided instead of the component corresponding to frame bodies 3 according to the first to fifth exemplary embodiments. Further, the tenth exemplary embodiment is different from the ninth exemplary embodiment in a configuration that capacitor 1 does not include second resin portions 5. Hereinafter, differences will be mainly described.

### First resin portion

A part of first resin portion 4 protrudes outward (upward) from opening face 60. Specifically, first surface portion 41 of first resin portion 4 is positioned outside opening face 60 (above opening face 60). As described above, first surface portion 41 and opening face 60 are not present on an identical plane.

First resin portion 4 is softer than case 6 as in the ninth exemplary embodiment.

### Cooler

Cooler 7 comes into contact with first resin portion 4 while pressing first resin portion 4 in a direction toward capacitor element 2. Specifically, flat face 70 of cooler 7 comes into close contact with first surface portion 41. Note that, depending on the pressing force, flat face 70 of cooler 7 may also be brought into close contact with opening edge portion 6a of case 6.

### Operations and effects

As in the fourth exemplary embodiment (FIG. 5), the tenth exemplary embodiment can also improve the heat dissipation of capacitor 1.

In particular, in the tenth exemplary embodiment, when cooler 7 is pressed against first surface portion 41 of first resin portion 4, first resin portion 4 is deformed, and thus, the pressure applied to first resin portion 4 can be reduced.

Even though the pressing force further increases in a state where cooler 7 abuts on opening edge portion 6a of case 6, the pressure applied to first resin portion 4 can be reduced because first resin portion 4 is softer than case 6.

Thus, according to the tenth exemplary embodiment, even though the pressure is applied to bring cooler 7 into close contact with the resin, it is possible to prevent the pressure from being directly applied to capacitor element 2. As a result, damage to capacitor element 2 can be suppressed.

Moreover, since first resin portion 4 that seals capacitor element 2 is harder than second resin portion 5, moisture is less likely to pass through first resin portion 4. Thus, a sealing effect can be enhanced.

### Modifications

At least two of the first to tenth exemplary embodiments may be appropriately combined.

In the first to eighth exemplary embodiments, cooler 7 includes both first cooler 71 and second cooler 72, but may include only one of first cooler 71 and second cooler 72.

In the first to tenth exemplary embodiments, bus bar 8 extends in the left-right direction, but may extend in the front-back direction.

In the first exemplary embodiment (FIG. 1) and the fourth exemplary embodiment (FIG. 5), a thermal interface material may be interposed between first surface portion 41 and flat face 70 of cooler 7 and/or between second surface portion 42 and flat face 70 of cooler 7.

In the fourth exemplary embodiment (FIG. 5), second resin portion 5 may be used instead of first resin portion 4.

In the fifth exemplary embodiment (FIG. 6), first surface portion 41 may be flush with first opening face 31, and second surface portion 42 may be flush with second opening face 32.

In the fifth exemplary embodiment (FIG. 6) and the eighth exemplary embodiment (FIG. 9), a thermal interface material may be interposed between flat face 50a of second resin portion 5a and flat face 70 of cooler 7 and/or between flat face 50b of second resin portion 5b and flat face 70 of cooler 7.

In the ninth exemplary embodiment (FIG. 10), first surface portion 41 may be flush with opening face 60.

In the ninth exemplary embodiment (FIG. 10), a thermal interface material may be interposed between flat face 50 of second resin portion 5 and flat face 70 of cooler 7.

In the tenth exemplary embodiment (FIG. 11), a thermal interface material may be interposed between first surface portion 41 and flat face 70 of cooler 7.

In the tenth exemplary embodiment (FIG. 11), second resin portion 5 may be used instead of first resin portion 4.

### Aspects

As is apparent from the above exemplary embodiments and modifications, the present disclosure includes aspects below. Hereinafter, reference numerals are given in parentheses only to clarify a correspondence relationship with the exemplary embodiments.

A first aspect is a capacitor (1), and capacitor (1) includes capacitor element (2), frame body (3) that surrounds capacitor element (2), frame body (3) including a pair of opening faces (30) facing each other, and first resin portion (4) that is disposed inside frame body (3), first resin portion (4) sealing capacitor element (2). Capacitor element (2) is disposed between the pair of opening faces (30). First resin portion (4) is softer than frame body (3).

According to this aspect, even though a pressure is applied to bring cooler (7) into close contact with the resin, it is possible to prevent the pressure from being directly applied to capacitor element (2).

A second aspect is capacitor (1) based on the first aspect. In the second aspect, capacitor (1) further includes cooler (7) that faces at least one of the pair of opening faces (30), cooler (7) being in contact with at least one of frame body (3) or first resin portion (4) while pressing at least one of frame body (3) or first resin portion (4) in a direction toward capacitor element (2).

According to this aspect, even though a pressure is applied to bring cooler (7) into close contact with the resin, it is possible to prevent the pressure from being directly applied to capacitor element (2).

A third aspect is capacitor (1), and capacitor (1) includes capacitor element (2), frame body (3) that surrounds capacitor element (2), frame body (3) including a pair of opening faces (30) facing each other, and first resin portion (4) that is disposed inside frame body (3), first resin portion (4) sealing capacitor element (2). Capacitor element (2) is disposed between the pair of opening faces (30). First resin portion (4) is positioned more inner than at least one of the pair of opening faces (30).

According to this aspect, even though a pressure is applied to bring cooler (7) into close contact with the resin, it is possible to prevent the pressure from being directly applied to capacitor element (2).

A fourth aspect is capacitor (1) based on the third aspect. In the fourth aspect, capacitor (1) further includes second resin portion (5) that covers first resin portion (4), second resin portion (5) being positioned closer to the at least one of the pair of opening faces (30) than first resin portion (4). Second resin portion (5) is softer than first resin portion (4).

According to this aspect, a pressure applied to capacitor element (2) can be reduced by second resin portion (5).

A fifth aspect is capacitor (1) based on the fourth aspect. In the fifth aspect, a part of second resin portion (5) protrudes outward from the at least one of the pair of opening faces (30).

According to this aspect, a pressure applied to capacitor element (2) can be reduced by second resin portion (5).

A sixth aspect is capacitor (1) based on the fourth or fifth aspect. In the sixth aspect, capacitor (1) further includes cooler (7) that is in contact with second resin portion (5) while pressing second resin portion (5) in a direction toward capacitor element (2).

According to this aspect, a pressure applied to capacitor element (2) can be reduced by second resin portion (5).

A seventh aspect is capacitor (1), and capacitor (1) includes capacitor element (2), and first resin portion (4) that seals capacitor element (2). First resin portion (4) includes first surface (41) and second surface (42) opposite to first surface (41). Capacitor element (2) is disposed between first surface (41) and second surface (42). At least one of first surface (41) or second surface (42) is recessed toward capacitor element (2) except for outer peripheral edge portion (4a).

According to this aspect, even though a pressure is applied to bring cooler (7) into close contact with the resin, it is possible to prevent the pressure from being directly applied to capacitor element (2).

An eighth aspect is capacitor (1) based on the seventh aspect. In the eighth aspect, capacitor (1) further includes second resin portion (5) that covers at least one of first surface (41) or second surface (42). Second resin portion (5) is softer than first resin portion (4).

According to this aspect, a pressure applied to capacitor element (2) can be reduced by second resin portion (5).

A ninth aspect is capacitor (1) based on the eighth aspect. In the ninth aspect, a part of second resin portion (5) protrudes outward from outer peripheral edge portion (4a) in a direction perpendicular to the at least one of first surface (41) or second surface (42).

According to this aspect, a pressure applied to capacitor element (2) can be reduced by second resin portion (5).

A tenth aspect is capacitor (1) based on the eighth or ninth aspect. In the tenth aspect, capacitor (1) further includes cooler (7) that is in contact with second resin portion (5) while pressing second resin portion (5) in a direction toward capacitor element (2).

According to this aspect, a pressure applied to capacitor element (2) can be reduced by second resin portion (5).

An eleventh aspect is capacitor (1), and capacitor (1) includes capacitor element (2), case (6) that houses capacitor element (2), case (6) including opening face (60), first resin portion (4) that is disposed inside case (6), first resin portion (4) sealing capacitor element (2), and second resin portion (5) that covers first resin portion (4). Second resin portion (5) protrudes outward from opening face (60).

According to this aspect, even though a pressure is applied to bring cooler (7) into close contact with the resin, it is possible to prevent the pressure from being directly applied to capacitor element (2).

A twelfth aspect is capacitor (1) based on the eleventh aspect. In the twelfth aspect, first resin portion (4) is softer than case (6). Second resin portion (5) is softer than first resin portion (4).

According to this aspect, second resin portion (5) is softer than first resin portion (4) and case (6), and thus, the pressure applied to capacitor element (2) can be reduced.

A thirteenth aspect is capacitor (1) based on the eleventh or twelfth aspect. In the thirteenth aspect, capacitor (1) further includes cooler (7) that is in contact with second resin portion (5) while pressing second resin portion (5) in a direction toward capacitor element (2).

According to this aspect, even though a pressure is applied to bring cooler (7) into close contact with the resin, it is possible to prevent the pressure from being directly applied to capacitor element (2).

A fourteenth aspect is capacitor (1), and capacitor (1) includes capacitor element (2), case (6) that houses capacitor element (2), case (6) including opening face (60), and first resin portion (4) that is disposed inside case (6), first resin portion (4) sealing capacitor element (2). First resin portion (4) protrudes outward from opening face (60).

According to this aspect, even though a pressure is applied to bring cooler (7) into close contact with the resin, it is possible to prevent the pressure from being directly applied to capacitor element (2).

A fifteenth aspect is capacitor (1) based on the fourteenth aspect. In the fifteenth aspect, first resin portion (4) is softer than case (6).

According to this aspect, first resin portion (4) is softer than case (6), and thus, the pressure applied to capacitor element (2) can be reduced.

A sixteenth aspect is capacitor (1) based on the fourteenth or fifteenth aspect. In the sixteenth aspect, capacitor (1) further includes cooler (7) that is in contact with first resin portion (4) while pressing first resin portion (4) in a direction toward capacitor element (2).

According to this aspect, even though a pressure is applied to bring cooler (7) into close contact with the resin, it is possible to prevent the pressure from being directly applied to capacitor element (2).

What is claimed is:

1. A capacitor comprising:
a capacitor element;
a frame body that surrounds the capacitor element, the frame body including a pair of opening faces facing each other; and
a first resin portion that is disposed inside the frame body, the first resin portion sealing the capacitor element, wherein:
the capacitor element is disposed between the pair of opening faces, and
the first resin portion is softer than the frame body.

2. The capacitor according to claim 1, further comprising a cooler that faces at least one of the pair of opening faces, the cooler being in contact with at least one of the frame body or the first resin portion while pressing the at least one of the frame body or the first resin portion in a direction toward the capacitor element.

3. A capacitor comprising:
a capacitor element;
a frame body that surrounds the capacitor element, the frame body including a pair of opening faces facing each other; and
a first resin portion that is disposed inside the frame body, the first resin portion sealing the capacitor element, wherein:
the capacitor element is disposed between the pair of opening faces, and
the first resin portion is positioned more inner than at least one of the pair of opening faces.

4. The capacitor according to claim 3, further comprising a second resin portion that covers the first resin portion, the second resin portion being positioned closer to the at least one of the pair of opening faces than the first resin portion,
wherein the second resin portion is softer than the first resin portion.

5. The capacitor according to claim 4, wherein a part of the second resin portion protrudes outward from the at least one of the pair of opening faces.

6. The capacitor according to claim 5, further comprising a cooler that is in contact with the second resin portion while pressing the second resin portion in a direction toward the capacitor element.

7. A capacitor comprising:
a capacitor element; and
a first resin portion that seals the capacitor element; wherein:
the first resin portion includes a first surface and a second surface opposite to the first surface,
the capacitor element is disposed between the first surface and the second surface, and
at least one of the first surface or the second surface is recessed toward the capacitor element except for an outer peripheral edge portion.

8. The capacitor according to claim 7, further comprising a second resin portion that covers the at least one of the first surface or the second surface,
wherein the second resin portion is softer than the first resin portion.

9. The capacitor according to claim 8, wherein a part of the second resin portion protrudes outward from the outer peripheral edge portion in a direction perpendicular to the at least one of the first surface or the second surface.

10. The capacitor according to claim 9, further comprising a cooler that is in contact with the second resin portion while pressing the second resin portion in a direction toward the capacitor element.

11. A capacitor comprising:
a capacitor element;
a case that houses the capacitor element, the case including an opening face;
a first resin portion that is disposed inside the case, the first resin portion sealing the capacitor element; and
a second resin portion that covers the first resin portion, wherein:
the second resin portion protrudes outward from the opening face.

12. The capacitor according to claim 11, wherein:
the first resin portion is softer than the case, and
the second resin portion is softer than the first resin portion.

13. The capacitor according to claim 12, further comprising a cooler that is in contact with the second resin portion while pressing the second resin portion in a direction toward the capacitor element.

14. A capacitor comprising:
a capacitor element;
a case that houses the capacitor element, the case including an opening face; and
a first resin portion that is disposed inside the case, the first resin portion sealing the capacitor element,
wherein the first resin portion protrudes outward from the opening face.

15. The capacitor according to claim 14, wherein the first resin portion is softer than the case.

16. The capacitor according to claim 15, further comprising a cooler that is in contact with the first resin portion while pressing the first resin portion in a direction toward the capacitor element.
